(19) United States
(12) Patent Application Publication
(10) Pub. No.: US 2025/0382507 A1
(43) Pub. Date: Dec. 18, 2025

(54) BIODEGRADABLE HOT MELT ADHESIVE COMPOSITIONS

(71) Applicant: H.B. Fuller Company, St. Paul, MN (US)

(72) Inventors: Dominic Matthews, Milton Keynes (GB); Beata Abram Eugenio, Milton Keynes (GB); Gavin Hill, Twyford (GB)

(21) Appl. No.: 19/240,197

(22) Filed: Jun. 17, 2025

Related U.S. Application Data
(60) Provisional application No. 63/661,369, filed on Jun. 18, 2024.
(60) Provisional application No. 63/661,375, filed on Jun. 18, 2024.

(51) Int. Cl. C09J 123/00; B65D 65/46; C09J 11/06; C09J 11/08

(52) U.S. Cl. CPC C09J 123/00; B65D 65/466; C09J 11/06; C09J 11/08

(57) ABSTRACT

A biodegradable hot melt adhesive composition including from 7.5% by weight to 95% by weight of an olefin polymer, from 0.15% by weight to 0.8% by weight of an antioxidant, from 0.005% by weight to 0.4% by weight of a saturated, or mono- or poly-unsaturated C 14-C 24 linear carboxylic acid, or an ester, anhydride or amide thereof, and from 0.02% by weight to 1.0% by weight of a transition metal compound, wherein the transition metal is selected from the group consisting of iron, manganese, copper, cobalt and cerium.

### CROSS REFERENCE TO RELATED APPLICATIONS

This application claims the benefit of U.S. Provisional Application No. 63/661,369, filed Jun. 18, 2024, and U.S. Provisional Application No. 63/661,375 filed Jun. 18, 2024, both which are incorporated herein.

### BACKGROUND

Hot melt adhesive compositions can form good adhesive bonds to fibrous substrates used in packaging consumer goods (e.g., Kraft paper, corrugated cardboard packaging materials, plastic materials, etc.), to substrates used to form disposable absorbent articles, and to tapes and labels for various end uses.

Hot melt adhesive compositions often include materials that are very stable, and do not break down enough to form fragments that are less than microplastic in size when disposed of in the terrestrial environment—if for example packaging material or an article including the hot melt adhesive composition ends up improperly disposed of in the environment (e.g., in a ditch, field, etc.). It would be desirable if the hot melt adhesive composition could completely break down in the environment such that no toxic residues, or even no microplastics remain.

### SUMMARY

In one aspect, the invention features a hot melt adhesive composition including from 7.5% by weight to 95% by weight of an olefin polymer, from 0.15% by weight to 1.0% by weight of an antioxidant, and from 0.25% by weight to 4% by weight of a masterbatch additive, the masterbatch additive including a saturated, or mono- or poly-unsaturated C 14-C 24 linear carboxylic acid, or an ester, anhydride or amide thereof, and transition metal compound, wherein the transition metal is selected from the group consisting of iron, manganese, copper, cobalt and cerium.

In another aspect, the invention features a hot melt adhesive composition including from 7.5% by weight to 95% by weight of an olefin polymer, from 0.15% by weight to 1.0% by weight of an antioxidant, from 0.005% by weight to 0.4% by weight of a saturated, or mono- or poly-unsaturated C 14-C 24 linear carboxylic acid, or an ester, anhydride or amide thereof, and from 0.02% by weight to 1.2% by weight of a transition metal compound, wherein the transition metal is selected from the group consisting of iron, manganese, copper, cobalt and cerium.

In another aspect, the invention features a hot melt adhesive composition including from 7.5% by weight to 95% by weight of an olefin polymer, from 0.15% by weight to 1.0% by weight of an antioxidant, from 0.005% by weight to 0.4% by weight of a saturated, or mono- or poly-unsaturated C 14-C 24 linear carboxylic acid, or an ester, anhydride or amide thereof, from 0.02% by weight to 1.0% by weight of a transition metal compound, wherein the transition metal is selected from the group consisting of iron, manganese, copper, cobalt and cerium and from 0.005% by weight to 0.6% by weight of an unsaturated synthetic rubber.

In one embodiment, the unsaturated synthetic rubber is selected from the group consisting of polyisoprene, styrene-isoprene, styrene-isoprene-styrene and a combination thereof. In another embodiment, the saturated, or mono- or poly-unsaturated C14-C24 linear carboxylic acid, or an ester, anhydride or amide thereof is selected from the group consisting of consisting of oleic acid, linoleic acid and cinnamic acid. In a different embodiment, the transition metal compound is a transition metal stearate.

In one embodiment, the hot melt adhesive composition passes British Standards Document PAS 9017:2020 Entitled: Biodegradation of polyolefins in an open-air terrestrial environment and Eco-toxicity tested under Organization for Economic Co-operation and Development (OECD) 208, OECD 211, and OECD 222.

In a different embodiment, the hot melt adhesive composition has a Brookfield viscosity of from 50 cP to 20,000 cP when tested at 160° C. In one embodiment, the hot melt adhesive composition has a Brookfield viscosity of from 100 cP to 10,000 cP when tested at 160° C.

In one embodiment, hot melt adhesive composition includes from 0.2% by weight to 0.9% by weight of the antioxidant, or even from 0.3% by weight to 0.8% by weight of the antioxidant. In one embodiment, the antioxidant is selected from the group consisting phenolic antioxidant, phosphite antioxidant and combinations thereof. In a different embodiment, the antioxidant includes a phenolic antioxidant.

In one embodiment, the olefin polymer is selected from the group consisting of propylene polymers and ethylene polymers. In a different embodiment, the hot melt adhesive composition includes from 10% by weight to 60%, 10% by weight to 70% by weight, or even 10% by weight to 80% by weight of the olefin polymer.

In one embodiment, the hot melt adhesive composition further includes a tackifying agent and a wax. In a different embodiment, the tackifying agent is a hydrogenated hydrocarbon tackifying agent. In another embodiment, the tackifying agent is bio-based.

In one aspect, the invention features a hot melt adhesive composition including from 10% by weight to 70% by weight of an olefin polymer, from 10% by weight to 65% by weight of a tackifying agent, from 5% by weight to 45% by weight of a material selected from the group consisting of wax, plasticizer, and a combination thereof, from 0.2% by weight to 0.7 by weight of an antioxidant, from 0.005% by weight to 0.4% by weight of a saturated, or mono- or poly-unsaturated C 14-C 24 linear carboxylic acid, or an ester, anhydride or amide thereof, from 0.02% by weight to 1.2% by weight of a transition metal compound, wherein the transition metal is selected from the group consisting of iron, manganese, copper, cobalt and cerium, and from 0.005% by weight to 0.6% by weight of an unsaturated synthetic rubber.

In one embodiment, the olefin polymer is a ethylene polymer having a MFR of from 5 grams (g)/10 minutes to 200 g/10 minutes when measured by according to ASTM D1238A-20 at 190° C. using a 2.16 kg load, the tackifying agent is a hydrogenated hydrocarbon, and the hot melt adhesive composition includes from 5% by weight to 45% by weight of a wax.

In one embodiment, the hot melt composition includes from 20% by weight to 100% by weight of sustainable components. In another embodiment, the sustainable component is selected from the group consisting of bio-based and recycled. In one embodiment, the sustainable component is bio-based. In another embodiment, the hot melt adhesive composition has a total bio-based carbon content according to ASTM 6866-20 of from 30% by weight to 100% by weight based on the total carbon content of the hot melt adhesive composition.

In another embodiment, the invention features an article that passes British Standards Document PAS 9017:2020 Entitled: Biodegradation of polyolefins in an open-air terrestrial environment comprising the hot melt adhesive composition. In one embodiment, the article is selected from the group consisting of case, carton, container, disposable paper product, paper bag, straws, disposable absorbent articles, labels, mailers, cigarettes, cigars and agriculture products.

The inventors have unexpectedly discovered hot melt adhesive compositions that can break down in an open-air terrestrial environment such that no toxic residues, or even no microplastics remain, while at the same time having an appropriate level of heat stability to enable application. This presents a difficult challenge as hot melt adhesive compositions are generally melted down in a tank and held at an elevated temperature (e.g., 110° C. to 190° C.) for an extended time prior to being applied (e.g., extruded, coated, sprayed, etc.) onto a substrate. The hot melt adhesive composition needs to be stable enough to enable application but not too stable so as to prevent breakdown after use.

Other features and advantages will be apparent from the following description of the preferred embodiments and from the claims.

### Glossary

In reference to the invention, these terms have the meanings set forth below:

The term “ethylene polymer” means a polymer derived from greater than 50% by weight ethylene.

The term “propylene polymer” means a polymer derived from greater than 50% by weight propylene.

The term “polybutene-1 polymer” means a polymer derived from greater than 50% by weight polybutene.

The term “wax” as used herein means a polymer or an oligomer having a heat of fusion greater than 100 Joules per gram (J/g) and a viscosity no greater than 750 centipoise (cP) at 190° C.

The term “microplastic” as used herein means solid polymer-containing particles, to which additives or other substances may have been added, having an average particle size distribution of between 100 nanometer and 5 millimeters.

“Renewable” is used herein to refer to a resource that is produced by a natural process at a rate comparable to its rate of consumption. The resource can be replenished naturally or by engineered agricultural techniques. Examples of renewable resources include but are not limited to plants (e.g., sugar cane, sugar beets, corn, wheat, potatoes, citrus fruit (e.g., oranges), woody plants, cellulosic waste, etc.), animals, fish, bacteria, fungi, and forestry products (e.g., pine and spruce trees). These resources can be naturally occurring, hybrids, or genetically engineered organisms. Natural resources such as crude oil, coal and natural gas are not considered renewable as they are derived from materials that will run out or will not be replenished for thousands or even millions of years.

“Bio-based” is used herein to refer to a material that is produced or is derived from at least 25% by weight of a renewable material as measured by a total bio-based carbon content according to ASTM 6866-20.

“Recycled” is used herein to refer to a material that is produced or is derived from at least 25% by weight of a recycled material. A recycled material is one which is made by collecting and processing materials that would otherwise be thrown away as trash and turning those material into new materials, this includes e.g., chemical recycling.

“Biomass balanced material” is used herein to refer to a material in which the bio-based origin cannot be detected by the radiocarbon method (ASTM 6866-20) due to time or dilution effects but is demonstrated by a biomass balance (BMB) method.

“Sustainable” is used herein to refer to a material that is selected from the group consisting of bio-based, recycled and biomass balanced.

### DETAILED DESCRIPTION

### Hot Melt Adhesive Composition

This invention is directed to a hot melt adhesive composition including from 7.5% by weight to 95% by weight of an olefin polymer, from 0.15% by weight to 1.0% by weight of an antioxidant, and from 0.25% by weight to 4% by weight of a masterbatch additive, the masterbatch additive including a saturated, or mono- or poly-unsaturated C 14-C 24 linear carboxylic acid, or an ester, anhydride or amide thereof, and transition metal compound, wherein the transition metal is selected from the group consisting of iron, manganese, copper, cobalt and cerium.

This invention is directed to a hot melt adhesive composition including a hot melt adhesive composition including from 7.5% by weight to 95% by weight of an olefin polymer, from 0.15% by weight to 1.0% by weight of an antioxidant, from 0.005% by weight to 0.4% by weight of a saturated, or mono- or poly-unsaturated C 14-C 24 linear carboxylic acid, or an ester, anhydride or amide thereof, and from 0.02% by weight to 1.2% by weight of a transition metal compound, wherein the transition metal is selected from the group consisting of iron, manganese, copper, cobalt and cerium.

The invention is also directed to a hot melt adhesive composition including from 7.5% by weight to 95% by weight of an olefin polymer, from 0.15% by weight to 1.0% by weight of an antioxidant, from 0.005% by weight to 0.4% by weight of a saturated, or mono- or poly-unsaturated C 14-C 24 linear carboxylic acid, or an ester, anhydride or amide thereof, from 0.02% by weight to 1.2% by weight of a transition metal compound, wherein the transition metal is selected from the group consisting of iron, manganese, copper, cobalt and cerium and from 0.005% by weight to 0.6% by weight of an unsaturated synthetic rubber.

The invention is further directed to a hot melt adhesive composition including from 10% by weight to 80% by weight of an olefin polymer, from 0.15% by weight to 1.0% by weight of an antioxidant, from 0.005% by weight to 0.4% by weight of a saturated, or mono- or poly-unsaturated C 14-C 24 linear carboxylic acid, or an ester, anhydride or amide thereof, from 0.02% by weight to 1.2% by weight of a transition metal compound, wherein the transition metal is selected from the group consisting of iron, manganese, copper, cobalt and cerium and from 0.005% by weight to 0.6% by weight of an unsaturated synthetic rubber.

The invention is also directed to a hot melt adhesive composition including from 10% by weight to 70% by weight of an olefin polymer, from 10% by weight to 65% by weight of a tackifying agent, from 5% by weight to 45% by weight of a material selected from the group consisting of wax, plasticizer, and a combination thereof, from 0.2% by weight to 0.8% by weight of an antioxidant, from 0.005% by weight to 0.4% by weight of a saturated, or mono- or poly-unsaturated C 14-C 24 linear carboxylic acid, or an ester, anhydride or amide thereof, from 0.02% by weight to 1.2% by weight of a transition metal compound, wherein the transition metal is selected from the group consisting of iron, manganese, copper, cobalt and cerium, and from 0.005% by weight to 0.6% by weight of an unsaturated synthetic rubber.

The invention is also directed to a hot melt adhesive composition including from 10% by weight to 70% by weight of an olefin polymer, from 10% by weight to 65% by weight of a tackifying agent, from 5% by weight to 45% by weight of a wax, from 0.3% by weight to 0.9% by weight of an antioxidant, from 0.005% by weight to 0.4% by weight of a saturated, or mono- or poly-unsaturated C 14-C 24 linear carboxylic acid, or an ester, anhydride or amide thereof, from 0.02% by weight to 1.2% by weight of a transition metal compound, wherein the transition metal is selected from the group consisting of iron, manganese, copper, cobalt and cerium, and from 0.005% by weight to 0.6% by weight of an unsaturated synthetic rubber.

The hot melt adhesive compositions of this invention completely break down in a natural (i.e., open air terrestrial) environment e.g., when improperly disposed of in a ditch, field, etc. By completely break down it is meant that the hot melt adhesive composition is converted into carbon dioxide, mineral salts, and microbial biomass by naturally occurring microorganisms in the environment and does not result in the formation of toxic residues.

The hot melt adhesive compositions of this invention, when used to form items comprising substrates that also break down in the natural environment can enable an entirely biodegradable item (e.g., package, bottle, disposable absorbent article, etc.). This helps provide a way to manage waste not currently captured by an alternate method (landfill, recycling, reuse etc.).

The hot melt adhesive composition compositions of this invention include an olefin polymer and optionally a material selected from the group consisting of tackifying agent, wax, plasticizer and combinations thereof. The hot melt adhesive composition can be free of biodegradative living organisms.

The hot melt adhesive composition can have a low enough viscosity to enable application at a temperature of from 110° C. to 190° C. Hot melt compositions are often melted down in a tank and then applied (e.g., extruded, coated, or sprayed onto a substrate). In order to be melted down in a tank and applied in such a manner, the hot melt adhesive composition has a Brookfield viscosity of no more than 50,000 centipoise (cP), no more than 30,000 cP, no more than 20,000 cP, no more than 15,000 cP, no more than 10,000 cP, or even no more than 5,000 cP when tested at the application temp of the hot melt adhesive composition.

The hot melt adhesive composition can have a Brookfield viscosity at 160° C. of from 50 cP, 100 cP, 200 cP, 500 cp, 1,000 cP to 1500 cP, 2000 cP, 3000 cP, 4000 cP, 5000 cP, 6000 cP, 7500 cP, 10,000 cP, 15,000 cP, 20,000 cP, 30,000 cP, 40,000 cP, 50,000 cP, or any two values therebetween.

The hot melt adhesive composition can include sustainable components, or even a high amount of sustainable components. The hot melt adhesive compositions can include from 30% by weight, 40% by weight, 50% by weight, 60% by weight to 70% by weight, 80% by weight, 90% by weight, 95% by weight, 100% by weight, or any two values therebetween of sustainable components.

The sustainable component can be selected from the group consisting of bio-based, recycled, and combinations thereof. Alternatively, the sustainable component can be a biomass balanced material.

The sustainable component can be selected from the group consisting of olefin polymer, tackifying agent, wax and plasticizer. The olefin polymer, the tackifying agent, the wax and the plasticizer can be any combination of non-sustainable, bio-based, recycled and biomass balanced.

The hot melt adhesive composition can have a total bio-based carbon content according to ASTM 6866-20 of at least 25% by weight, at least 30% by weight, at least 50% by weight, at least 60% by weight, at least 70% by weight, at least 80% by weight, or even at least 90% by weight of the total carbon content.

The sustainable component can have a total bio-based carbon content according to ASTM 6866-20 of from 25% by weight, 35% by weight, 40% by weight, 45% by weight to 75% by weight, 80% by weight, 85% by weight, 90% by weight, 95% by weight, or even 100% by weight based on the total carbon content.

The hot melt adhesive composition is stable during application and use, while being able to completely break down when discarded in a natural open air terrestrial environment.

The hot melt adhesive composition can be aged at 160° C. according to the Heat Stability test for 24 hours, 48 hours, or even 72 hours without skinning.

The hot melt adhesive composition can pass the British Standards Document PAS 9017:2020 Entitled: Biodegradation of polyolefins in an open-air terrestrial environment.

The hot melt adhesive composition can fully degrade in the environment and does not result in toxic residues. The hot melt composition can further pass ecotoxicity testing such as Organization for Economic Co-operation and Development (OECD) 208, OECD 211, and OECD 222.

### Olefin Polymer

The hot melt adhesive composition includes one or more olefin polymers. Useful olefin polymers include homopolymers, copolymers and higher order polymers such as e.g., terpolymers. Useful olefin polymers can comprise any combination of olefin monomers. Useful olefin monomers include those selected from the group consisting of ethylene, propylene, isoprene, butene, butadiene, pentene, hexene, heptene, octene, nonene, decene, dodecene, 4-methyl-pentene-1, 3-methyl pentene-1,3,5,5-trimethyl-hexene-1, 5-ethyl-1-nonene, 1,9-decadiene, and combinations thereof. The olefin polymer can be selected from the group consisting of ethylene polymer, propylene polymer, and polybutene-1 polymer.

The olefin polymer can consist entirely of olefin monomers. Alternately, the olefin polymer can include functional groups. The functional groups useful herein are not limited and can include silane, maleic anhydride, hydroxyl groups and groups that include vinyl unsaturation examples of which include vinyl acetate, alkyl acrylate, alkyl methacrylate, and combinations thereof. Useful olefin polymers including vinyl unsaturation include, e.g., ethylene vinyl acetate, ethylene acrylate, ethylene methacrylate, ethylene methyl methacrylate, ethylene n-butyl acrylate, ethylene 2-ethyl hexyl acrylate, ethylene octyl acrylate, and combinations thereof.

The olefin polymer can be prepared using a variety of catalysts including, a single site catalyst (e.g., metallocene catalysts (e.g., metallocene-catalyzed ethylene/alpha-olefin copolymers)), multiple single site catalysts, non-metallocene heteroaryl catalysts, Ziegler Natta catalysts, and combinations thereof.

Useful olefin polymers exhibit a density of no greater than 0.93 g/cm³, 0.90 g/cm³, no greater than 0.89 g/cm³, or even no greater than 0.88 g/cm³.

Useful olefin polymers exhibit a melt flow rate of from 0.5, 3, 5, 10, 15, 20, 30, 40, 50 to 200, 300, 400, 500, 600, 800, 1000, 1500, 2,000 grams (g)/10 minutes, or any two values therebetween as measured according to ASTM D1238A-20 at 190° C. using a 2.16 kg load.

The olefin polymer can be present in an amount of at least 40% by weight, at least 42% by weight, at least 44% by weight, at least 46% by weight, from 40% by weight to 60% by weight, or even from 42% by weight to 55% by weight. A relatively higher polymer content can assist in lowering the density of the hot melt adhesive composition and can lead to improved mileage i.e., less adhesive is needed to form the same bonds.

The hot melt adhesive composition can include from 5% by weight, 7.5% by weight, 8.5% by weight, 10% by weight, 12% by weight, 15% by weight to 25% by weight, 30% by weight, 40% by weight, 50% by weight, 60% by weight, 70% by weight, 80% by weight, 85% by weight, 87% by weight, 90% by weight, 92% by weight, 95% by weight, or any two values therebetween of the olefin polymer.

### Ethylene Polymer

The olefin polymer can be an ethylene polymer.

The ethylene polymer can be a homopolymer. Useful ethylene homopolymers include e.g., EPOLENE C16 and EPOLENE C18 available from Westlake Chemical Corporation (Houston, Texas).

The ethylene polymer can be a copolymer of ethylene and a monomer that includes vinyl unsaturation examples of which include vinyl acetate, alkyl acrylate, alkyl methacrylate, and combinations thereof. Useful olefin polymers including vinyl unsaturation include, e.g., ethylene vinyl acetate, ethylene acrylate, ethylene methacrylate, ethylene methyl methacrylate, ethylene n-butyl acrylate, ethylene 2-ethyl hexyl acrylate, ethylene octyl acrylate, and combinations thereof.

The ethylene polymer can be an ethylene/alpha-olefin copolymer. Useful ethylene/alpha-olefin copolymers exhibit a melt flow rate of from 3, 5, 10, 15, 20, 30, 40, 50 to 200, 300, 400, 500, 600, 800, 1000, 1500, 2,000 grams (g)/10 minutes, or any two values therebetween as measured according to ASTM D1238A-20 at 190° C. using a 2.16 kg load. Useful ethylene/alpha-olefin copolymers exhibit a density of no greater than 0.93 g/cm3, no greater than 0.90 g/cm³, no greater than 0.89 g/cm³, or even no greater than 0.88 g/cm³. The ethylene/alpha-olefin copolymer is derived from ethylene and an alpha-olefin co-monomer, e.g., alpha-olefin monomers having at least three carbon atoms, at least four carbon atoms, at least six carbon atoms, at least eight carbon atoms, and combinations of such monomers. Suitable alpha-olefin co-monomers include, e.g., propylene, butene, pentene, hexene, heptene, octene, nonene, decene, dodecene, 4-methyl-pentene-1, 3-methyl pentene-1,3,5,5-trimethyl-hexene-1, 5-ethyl-1-nonene, 1,9-decadiene, and combinations thereof. Specific examples of suitable ethylene/alpha-olefin copolymers include ethylene-propylene, ethylene-butene, ethylene-hexene, ethylene-octene, and combinations thereof.

The ethylene/alpha-olefin copolymer can be prepared using a variety of catalysts including, e.g., a single site catalyst (e.g., metallocene catalysts (e.g., metallocene-catalyzed ethylene/alpha-olefin copolymers)), multiple single site catalysts, non-metallocene heteroaryl catalysts, Ziegler Natta catalysts, and combinations thereof.

Useful ethylene/alpha-olefin copolymers are commercially available under a variety of trade designations including, e.g., the AFFINITY series of trade designations from The Dow Chemical Company (Midland, Michigan) including AFFINITY GA 1900 and AFFINITY GA 1950 ethylene-octene copolymers, the ENGAGE series of trade designations from The Dow Chemical Company (Midland, Michigan) including ENGAGE 8407 and ENGAGE 8200, the QUEO series of trade designations from Borealis GmbH. (Netherlands) (including QUEO 7030LA and QUEO 7007LA, and the SOLUMER and SOLUTACK trade designations from SK Chemicals (Korea) including SOLUTACK 7405, SOLUTACK 6805, SOLUTACK 7410, SOLUTACK 6810 and SOLUMER 8730.

The hot melt adhesive composition can include from 5% by weight, 7.5% by weight, 8.5% by weight, 10% by weight, 12% by weight, 15% by weight to 25% by weight, 30% by weight, 40% by weight, 50% by weight, 60% by weight, 70% by weight, 80% by weight, 85% by weight, 87% by weight, 90% by weight, 92% by weight, 95% by weight of the ethylene polymer, or any two values therebetween.

### Propylene Polymer

The olefin polymer can be a propylene polymer.

Useful propylene polymers include, e.g., propylene homopolymers, propylene/alpha-olefin copolymers that are derived from greater than 50% by weight propylene and at least one alpha-olefin co-monomer, and combinations thereof. Useful alpha-olefin comonomers include, e.g., alpha-olefin monomers having at least two carbon atoms, at least four carbon atoms, from four carbon atoms to eight carbon atoms, and combinations of such monomers, including, e.g., ethylene, butene, pentene, hexene, heptene, octene, nonene, decene, dodecene, 4-methyl-pentene-1, 3-methyl pentene-1,3,5,5-trimethyl-hexene-1, 5-ethyl-1-nonene, 1,9-decadiene, and combinations thereof. Specific examples of suitable propylene-alpha-olefin copolymers include propylene-ethylene, propylene-butene, propylene-hexene, propylene-octene, and combinations thereof.

The propylene polymer can be prepared using a variety of catalysts including, e.g., a single site catalyst (e.g., metallocene catalysts (e.g., metallocene-catalyzed propylene polymers)), multiple single site catalysts, non-metallocene heteroaryl catalysts, Ziegler Natta catalysts, and combinations thereof.

The propylene polymer can exhibit heat of fusion of from 0 J/g to 70 J/g or even from 5 J/g to 40 J/g. The propylene polymer preferably a density of no greater than 0.93 g/cm³, no greater than 0.90 g/cm³, no greater than 0.89 g/cm³, or even no greater than 0.88 g/cm³.

The propylene polymers can exhibit a melt flow rate of from 3, 5, 10, 15, 20, 30, 40, 50 to 200, 300, 400, 500, 600, 800, 1000, 1500, 2,000 grams (g)/10 minutes, or any two values therebetween as measured according to ASTM D1238A-20 at 190° C. using a 2.16 kg load.

Useful propylene polymers are commercially available under a variety of trade designations including, e.g., the VISTAMAXX series of trade designations from ExxonMobil Chemical Company (Houston, Texas) including VISTAMAXX 6202, VISTAMAX 6502, VISTAMAXX 8880, VISTAMAXX 8780, and VISTAMAXX 8380 propylene-ethylene copolymers, the LICOCENE series of trade designations from Clariant Int'l Ltd. (Muttenz, Switzerland) including, e.g., LICOCENE PP 2602, LICOCENE PP 3602, and LICOCENE PP 1602 propylene-ethylene copolymers, propylene homopolymers available under the L-MODU series of trade designations from Idemitsu Kosan Co., Ltd. (Japan) including L-MODU S410 polypropylene and L-MODU S400 polypropylene.

The hot melt adhesive composition can include from 5% by weight, 7.5% by weight, 8.5% by weight, 10% by weight, 12% by weight, 15% by weight to 25% by weight, 30% by weight, 40% by weight, 50% by weight, 60% by weight, 70% by weight, 80% by weight, 85% by weight, 87% by weight, 90% by weight, 92% by weight, 95% by weight, or any two values therebetween of the propylene polymer.

### Optional Polymers

The hot melt adhesive composition can optionally include additional polymers such as e.g., styrene block copolymers e.g., hydrogenated styrene block copolymers including, e.g., styrene-ethylene-butylene-styrene, styrene-ethylene-propylene-styrene, styrene-ethylene-butylene-styrene-styrene, and combinations thereof.

### Wax

The hot melt adhesive composition can include at least one wax. Useful waxes have a heat of fusion of greater than 100 J/g, or even greater than 200 J/g, and a drop melting point of at least 80° C., at least 90° C., at least 95° C., from 80° C. to 120° C., from 85° C. to 115° C. and preferably no greater than 120° C. The wax component optionally can additionally include a wax with a drop melting point greater than 105° C., but the overall wax component (i.e., the wax or the mixture of waxes, where more than one wax is present in the hot melt adhesive composition) has a drop melting point of no greater than 105° C.

Suitable classes of waxes include, e.g., Fischer-Tropsch waxes, polyolefin waxes (e.g., polypropylene waxes and polyethylene waxes), microcrystalline waxes, metallocene waxes, paraffin waxes, and combinations thereof. Useful Fischer-Tropsch waxes are commercially available under a variety of trade designations including, e.g., the SASOLWAX series of trade designations from Sasol Wax North America Corporation (Hayward, California) including, e.g., SASOLWAX H1, SASOLWAX H105 and SASOLWAX C80, Fischer-Tropsch wax, and waxes under the SARAWAX series of trade designations from Shell Corporation (Malasia), including, e.g., SHELL GTL waxes. Useful polyethylene waxes are commercially available under a variety of trade designations including, e.g., the EPOLENE series of trade designations from Westlake Chemical Corporation (Houston, Texas) including, e.g., EPOLENE N-34 and EPOLENE N-35 polyethylene waxes, and the POLYWAX series of trade designations including POLYWAX 400, POLYWAX 500, POLYWAX 600, POLYWAX 655, and POLYWAX 725 polyethylene waxes from NuCera Solutions (Houston, Texas). Useful microcrystalline waxes are commercially available under a variety of trade designations including, e.g., the MICROSERE series of trade designations from Alfa Chemicals (United Kingdom) including MICROSERE 5999A microcrystalline wax. Useful commercially available paraffin waxes include, e.g., paraffin waxes available under the PARVAN series of trade designations from ExxonMobil Chemical Company (Houston, Texas) including, e.g., PARVAN 1580 and PARVAN 1520 paraffin waxes, and under the CALUMET series of trade designations from Calumet Specialty Products Partners, LP (Indianapolis, Indiana) including CALUMET FR-6513 paraffin wax.

The hot melt adhesive composition includes from 0% by weight, 2% by weight, 3% by weight, 5% by weight, 7.5% by weight, 10% by weight, 15% by weight to 25% by weight, 30% by weight, 35% by weight, 40% by weight or any two values therebetween of a wax.

### Tackifying Agent

The hot melt adhesive composition can include a tackifying agent. Useful tackifying agents have a T_{g} of at least 40° C., at least 60° C., or even at least 80° C., and a Ring and Ball softening point of from 70° C. to 160° C., or even from 80° C. to 140° C.

Suitable hydrogenated tackifying agents include, e.g., aliphatic hydrocarbon resins, fully hydrogenated aliphatic hydrocarbon resins, cycloaliphatic hydrocarbon resins, fully hydrogenated cycloaliphatic hydrocarbon resins, aromatic modified aliphatic hydrocarbon resins, fully hydrogenated aromatic modified aliphatic hydrocarbon resins, and combinations thereof. Specific examples of useful aliphatic and cycloaliphatic petroleum hydrocarbon resins include, e.g., branched, unbranched, and cyclic C5 resins, C9 resins, and C10 resins, and combinations thereof.

Other suitable tackifying agents include rosin-based tackifying agents, terpene-based tackifying agents, and combinations thereof. Useful rosin-based tackifying agents include rosin acids, rosin esters, wood rosin, tall oil rosin, gum rosin, distilled rosin, hydrogenated rosin, dimerized rosin, polymerized rosin, and combinations thereof. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, phenolic-modified pentaerythritol esters of rosin, and combinations thereof.

Useful commercially available hydrogenated tackifying agents are available under a variety of trade designations including, e.g., the EASTOTAC series of trade designations from Eastman Chemical Company (Kingsport, Tennessee) including, e.g., EASTOTAC H-100R, EASTOTAC H-100W, and EASTOTAC H-100L, the ESCOREZ series of trade designations from ExxonMobil Chemical Company (Houston, Texas) including, e.g., ESCOREZ 1310LC, ESCOREZ 5400, ESCOREZ 5415, ESCOREZ 5600, ESCOREZ 5615, and ESCOREZ 5690, the ARKON series of trade designations from Arakawa Europe GmbH (Germany) including, e.g., ARKON P-100 hydrogenated hydrocarbon resin, the LUHOREZ series of trade designations from Zibo Luhua Hongjin New Material Group Co. (Shandong Province, China) including LUHOREZ HD 1120 and HC120 from Hanwha Solutions (South Korea).

Useful commercially available rosin-based tackifying agents are available under a variety of trade designations including, e.g., the SYLVALITE series of trade designations from Arizona Chemical Company (Jacksonville, Florida) including, e.g., SYLVALITE RE-100L rosin ester, SYLVALITE 9100 rosin ester, KOMOTAC KA100L gum rosin pentaerythritol ester from Komo Pine Chemicals, Guangzhou Komo Chemical Co., Ltd. (China), the WESTREZ and ALTATAC series of trade designations from Ingevity Corp. (North Charleston, South Carolina) including, e.g., WESTREZ 5101P, WESTREZ 5295, ALTATAC 1000P, and ALTATAC 1000 rosin esters, the FORAL series of trade designations from Eastman (Kingsport, Tennessee) including, e.g., FORAL 105-E gum rosins and FORAL AX rosin acid, and the TECKROS series of trade designations from Teckrez Inc. (Fleming Island, Florida) including, e.g., TECKROS D85 and D95 rosin esters.

Examples of useful polyterpene resins include non-hydrogenated polyterpene resins, hydrogenated polyterpene resins, and copolymers and terpolymers of natural terpenes (e.g., styrene-terpene, alpha-methyl styrene-terpene and vinyl toluene-terpene), and combinations thereof. Polyterpene resins are commercially available under a variety of trade designations including, e.g., the SYLVARES series of trade designations from Kraton Corp. (Houston, Texas) including SYLVARES 6100 terpene resin, and under the DERCOLYTE series of trade designations from DRT Company (Dax, France) including, e.g., DERCOLYTE A115 terpene resin.

The hot melt adhesive composition can include from 0% by weight, 5% by weight, 10% by weight, 15% by weight, 20% by weight 25% by weight, 30% by weight to 35% by weight, 40% by weight, 45% by weight, 50% by weight, 55% by weight, 60% by weight, 65% by weight, or any two values therebetween of a tackifying agent.

### Plasticizer

Useful plasticizers include plasticizers that are liquid at room temperature. The term “liquid” as used in reference to the plasticizer means that the plasticizer exhibits a kinematic viscosity of no greater than 5000 centistokes (cS) at 25° C. as determined according to ASTM D445 and a pour point of no greater than 30° C. as determined according to ASTM D97. Useful classes of plasticizers include, e.g., oils, and oligomeric and low molecular weight polymeric plasticizers that are liquid at room temperature. Particularly useful plasticizers include naphthenic oil, paraffinic oil (e.g., cycloparaffin oils), mineral oils, gas to liquid oils, and combinations thereof. The plasticizer can be present in a modified (e.g., grafted) form. The plasticizer can be modified with a functional group capable of participating in hydrogen bonding (e.g., organic acid (e.g., carboxylic acid), anhydride (e.g., maleic anhydride), amide, amine, urea, carbamate, hydroxyl, carbonate, ketone, etc.

Useful plasticizers are commercially available under a variety of trade designations including, e.g., CALSOL 5550 naphthenic oil and DRAKEOL 35 paraffinic oil, from Calumet Specialty Products Partners, LP (Indianapolis, Indiana), and PURETOL 35 paraffinic oil from Petro-Canada Lubricants Inc. (Ontario, Canada), CATENEX T145 paraffinic oil from Shell Oil Products US (Houston, Texas), NYFLEX 223 naphthenic oil from Nynas AB (Stockholm, Sweden), KAYDOL mineral oil from Sonneborn (Tarrytown New York), KRYSTOL 550 mineral oil from Petrochem Carless Limited (Surrey, England), RISELLA X430 natural gas to liquid oil from Shell Oil Products US (Houston, Texas) and LIR 403 and LIR 50 liquid rubber available from Kuraray Company, LTD. (Kashima, Japan).

The hot melt adhesive composition can include from 0% by weight, 2% by weight, 5% by weight, 10% by weight, 12% by weight, 15% by weight to 25% by weight, 35% by weight, 40% by weight, or any two values therebetween of plasticizer.

### Antioxidant

The hot melt adhesive composition includes at least one antioxidant. The amount of antioxidant in the hot melt adhesive composition includes the total of the antioxidant attributed to the masterbatch additive and the additional antioxidant added to the hot melt adhesive composition when the hot melt adhesive is formed. The antioxidant attributable to the masterbatch additive is a relatively small amount, no more than 0.2% by weight. The hot melt adhesive composition can include any number of antioxidants, preferably from 1 to 4, 1 to 3, 1 to 2, or even 1 antioxidant.

The hot melt adhesive composition can include an antioxidant selected from the group consisting of phenolic antioxidant, phosphite antioxidant, vitamin E, and combinations thereof. The hot melt adhesive composition can include an antioxidant selected from the group consisting of phenolic antioxidant, phosphite antioxidant, and combinations thereof.

The hot melt adhesive composition can be free of phosphonate antioxidants.

The inventors have discovered that the amount and type of antioxidant is critical to achieving enough heat stability to enable application at an elevated temperature while not interfering with decomposition in the end article.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP), di-stearyl-3,3′-thiodipropionate (DSTDP), and combinations thereof.

Useful antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, New Jersey), and ETHYL 702 4,4′-methylene bis(2,6-di-tert-butylphenol).

The hot melt adhesive composition can include from 0.15% by weight, 0.2% by weight, 0.25% by weight to 0.3% by weight, 0.35% by weight, 0.4% by weight, 0.45% by weight, 0.5% by weight, 0.55% by weight, 0.6% by weight, 0.65% by weight, 0.7% by weight, 0.75% by weight, 0.80% by weight, 0.85% by weight, 0.90% by weight, 0.95% by weight, 1.0% by weight, or any two values therebetween of antioxidant.

The hot melt composition can include no greater than 1.0% by weight, no greater than 0.9% by weight, no greater than 0.8% antioxidant, no greater than 0.7% antioxidant, no greater than 0.65% by weight, or even no greater than 0.6% antioxidant.

### Masterbatch Additive

The hot melt adhesive composition includes a masterbatch additive. The masterbatch additive includes the materials needed for the biodegradation of the hot melt adhesive composition. The various materials can be combined (e.g., extrusion, compaction, etc.) and supplied in a pellet form.

The masterbatch additive can include a saturated, or mono- or poly-unsaturated linear C 14-C 24 carboxylic acid or an ester, anhydride, or amide thereof, one or more transition metal compounds, and optionally a synthetic rubber.

The hot melt adhesive composition can include from 0.25% by weight, 0.5% by weight, 0.75% by weight, 1.0% by weight, 1.25% by weight, 1.5% by weight, 1.75% by weight to 2.25% by weight, 2.5% by weight, 2.75% by weight, 3.0% by weight, 3.25% by weight, 3.5% by weight, 4.0% by weight of the masterbatch additive, or any two numbers therebetween.

Useful examples of masterbatch additives include Masterbatch additive 3.1, commercially available from Polymateria Limited (London, U.K.).

The masterbatch additive includes a saturated, or mono- or poly-unsaturated linear C14-C24 carboxylic acid or an ester, anhydride or amide thereof. The term carboxylic acid refers to the range of molecules containing a carboxylic acid —(COOH) moiety. The carboxylic acid of the present invention can be saturated (i.e., have only single carbon-carbon bonds), or be mono- or polyunsaturated (i.e., have one or more double carbon-carbon bonds along its carbon backbone). It can have a carbon backbone containing between 14 and 24 (preferably 16 and 20) carbon atoms, meaning it can have at least one double bond in the carbon backbone. The carbon backbone of the carboxylic acid may be linear, branched, or aromatic. The saturated, mono- or poly-unsaturated carboxylic acid can be a C16-C20 carboxylic acid. The carboxylic acid can be selected from the group consisting of oleic acid, linoleic acid and cinnamic acid.

The carboxylic acid or an ester, anhydride or amide thereof component can be “free” or “non-coordinated”, in the sense that they do not form a part of a transition metal compound.

When the saturated, or mono- or poly-unsaturated linear C14-C24 carboxylic acid comprises an ester of a saturated, or mono- or poly-unsaturated C16-C20 carboxylic acid the alcohol component preferably comprises a C1-C30 alcohol, more preferably a saturated straight chain C1-C30 alcohol.

When the saturated, or mono- or poly-unsaturated linear C14-C 24 carboxylic acid comprises an anhydride of a saturated, or mono- or poly-unsaturated C16-C20 carboxylic acid, the anhydride may or may not be symmetrical. The second carboxylic acid component preferably comprises a C1-C30 carboxylic acid, more preferably a saturated straight chain C1-C30 carboxylic acid.

When the saturated, or mono- or poly-unsaturated linear C14-C24 carboxylic acid comprises an amide of a saturated, or mono- or poly-unsaturated C16-C20 carboxylic acid the amide may be a primary, secondary, or tertiary amide. Where a secondary or tertiary amide is present, each of the carbon chains preferably comprises from 1 to 30 carbon atoms, more preferably each carbon chain is a C1-C30 alkyl group.

The hot melt adhesive composition can include from 0.005% by weight, 0.01% by weight, 0.02% by weight, 0.03% by weight, 0.04% by weight to 0.06% by weight, 0.08% by weight, 0.10% by weight 0.15% by weight, 0.20% by weight, 0.3% by weight, 0.4% by weight, or any two values therebetween of the saturated, or mono- or poly-unsaturated linear C 14-C24 carboxylic acid or an ester, anhydride, or amide thereof.

The masterbatch additive includes a transition metal compound which catalyzes the degradation of the hot melt adhesive composition. The term transition metal as used herein refers to any 5 of the metallic elements of groups IVB-VIII, IB, and IIB, or 4-12 in the periodic table. The masterbatch additive can include more than one transition metal compound. The masterbatch additive can include from 1 to 3, or even 2 transition metal compounds.

The transition metal compound can be formed from a transition metal selected from the group consisting of iron, manganese, copper, cobalt, and cerium. The transition metal compound can be a transition metal stearate.

By ‘transition metal compounds’ it is meant the transition metal compound when formed as a salt (i.e., with one or more ligands). For example, iron could be provided as iron stearate (i.e., the salt of iron and stearic acid). Further references to the amount of the transition metal compound (in wt. %) refer to the amount when in a salt.

The ligands of the metal compounds can be inorganic ligands and/or saturated organic ligands. The organic ligands can be C6-C20, mono- or di-functional. Examples include carboxylic acids, acetylacetone, triazacyclononane and the like. Preferably the transition metal compounds comprise moieties selected from stearate, carboxylate, acetylacetonate, triazacyclononane, or combinations of two or more thereof.

Certain non-ionic ligands that play an active role in the degradation may also be included. Where present, the non-ionic ligands are preferably selected from amines, imines, amides, phosphites, phosphines, and carbenes. Such non-ionic ligands can have an advantageous effect on the degradation rate of the hot melt adhesive composition whilst maintaining the essential material properties. When present, non-ionic ligands preferably constitute at least 5% of the ligands and preferably up to 50% of the ligands, preferably 10 to 40% of the ligands.

The hot melt adhesive composition can include 0.02% by weight, 0.03% by weight, 0.04% by weight, 0.06% by weight, 0.08% by weight, 0.1% by weight to 0.3% by weight, 0.4% by weight, 0.6% by weight, 0.8% by weight, 0.9% by weight, 1.0% by weight, 1.2% by weight or any two values therebetween of transition metal compounds.

The masterbatch additive can optionally include a rubber, preferably a synthetic rubber. The term rubber as used herein refers to viscous, elastic polymers. Rubbers are amorphous polymers which exist at temperatures above their glass transition temperature. Preferably, the rubber of the present invention is an unsaturated rubber. Preferably, the unsaturated rubber is one or more copolymers of isobutene and isoprene, and/or a polybutadiene and/or styrene-butadiene-styrene, and/or a natural rubber.

The synthetic rubber can be an unsaturated rubber. The synthetic rubber can be selected from the group consisting of polyisoprene, styrene-isoprene (SI), styrene-isoprene-styrene (SIS) and a combination thereof. The rubber of the present invention can be a synthetic rubber that comprises polyisoprene, styrene-isoprene (SI), styrene-isoprene-styrene (SIS), or a blend of two or more thereof.

Natural rubber is generally supplied as a latex emulsion that requires evaporation of the liquid to remove the solvent. Natural rubber can be sticky and difficult to extrude, so can be blended with other synthetic rubbers or appropriate additives to overcome this difficulty. The natural rubber can be cis or trans natural rubber, and preferably the natural rubber comprises, or consists of trans natural rubber.

Natural rubber is often called ‘Indian rubber’, ‘latex’, or ‘Amazonian rubber’, and consists of polymers of the isoprene, with minor impurities of other organic compounds. It can be 5 harvested from various natural sources, such as the Gutta-percha tree or the Pari rubber tree, or other appropriate sources.

The rubber content may improve the mechanical properties of the hot melt adhesive composition. Additionally, rubbers are generally less chemically stable than the bulk polyolefin. Accordingly, the rubber content may improve the degradation rate without adversely affecting the physical properties of the hot melt adhesive composition. In this way it can act as a co-catalyst. The hot melt adhesive composition can include from 0% by weight, 0.005% by weight, 0.01% by weight, 0.015% by weight, 0.02% by weight 0.03% by weight to 0.06% by weight, 0.08% by weight, 0.1% by weight, 0.15% by weight, 0.2% by weight, 0.3% by weight, 0.4% by weight, 0.5% by weight, 0.6% by weight or any two values therebetween of the rubber, or even the synthetic rubber.

The masterbatch additive can optionally include other materials. The masterbatch additive can optionally include mineral acid scavengers (e.g., calcium oxide, hydrotalcites, and zinc oxides), oxygen generating additives (e.g., nitrates, peroxides, sulphates, phosphates, and combinations thereof), starch and a carrier material (e.g., olefin polymer).

The masterbatch additive can optionally include antioxidant. The inventors have found that the amount of antioxidant, attributed to the masterbatch additive when used in the hot melt adhesive composition amounts to no greater than 0.2% of the total antioxidant present in the hot melt adhesive composition.

### Additional Components

The hot melt adhesive composition optionally includes a variety of additional components including, e.g., stabilizers, adhesion promoters, ultraviolet light stabilizers, rheology modifiers, corrosion inhibitors, colorants (e.g., pigments and dyes), fillers, flame retardants, nucleating agents, plasticizers, and combinations thereof.

### Uses

The hot melt adhesive compositions of this invention can be applied to or incorporated in a variety of articles. The hot melt adhesive compositions of this invention, when used to form articles comprising substrates that also are biodegradable i.e., break down in the natural environment can enable an entirely biodegradable article.

The hot melt adhesive composition can be used to bond to a variety of substrates including, e.g., cardboard, coated cardboard, paperboard, fiber board, virgin and recycled kraft, high and low density kraft, chipboard, treated and coated kraft and chipboard, and corrugated versions of the same, clay coated chipboard carton stock, composites, leather, fibers, substrates made from fibers (e.g., virgin fibers, recycled fibers, synthetic polymer fibers (e.g., nylon, rayon, polyesters, acrylics, polypropylenes, polyethylene, polyvinyl chloride, polyurethane), glass fibers, cellulose fibers, and combinations thereof), release liners, porous substrates (e.g., woven and nonwoven webs (e.g., webs made from fibers (e.g., yarn, thread, filaments, microfibers, blown fibers, and spun fibers), and perforated films), cellulose substrates, sheets (e.g., paper, and fiber sheets), paper products, tape backings, tape backings, and combinations thereof.

The hot melt adhesive composition is useful for bonding a substrate or substrates in a variety of applications and constructions including, e.g., paper products (e.g., paper bags), packages, bags, boxes, cartons, containers (e.g., coffee cups, food containers (e.g., salad/sandwich boxes) cases, trays, multi-wall bags, fiber based substrate lamination (e.g., formation of corrugated cardboard), articles that include attachments (e.g., straws and caps drink boxes), e-commerce mailers (e.g., paper mailers, etc.), ream wrap, cigarettes (e.g., plug wrap), cigars, filters (e.g., pleated filters and filter frames), book bindings, paper products including, e.g., paper towels (e.g., multiple use towels), toilet paper, tissues (e.g., facial tissue), wipes, agriculture products (e.g., plug pots, field covers), and combinations thereof.

The hot melt adhesive compositions of this invention are particularly useful for end of line packaging where the hot melt adhesive composition is used to seal or form a carton, container or tray. By using a hot melt adhesive composition of this invention, the degradation of the final packaging is improved. The hot melt adhesive composition works well for containers that need high heat resistance, cold resistance e.g., freezer grades, or a combination thereof.

The hot melt adhesive composition is useful for bonding a first substrate to a second substrate in a variety of applications and constructions including, e.g., packaging, bags, boxes, cartons, cases, trays, multi-wall bags, articles that include attachments (e.g., straws attached to drink boxes), ream wrap, cigarettes (e.g., plug wrap), filters (e.g., pleated filters and filter frames), bookbinding, paper products including, e.g., paper towels (e.g., multiple use towels), toilet paper, facial tissue, wipes, tissues, towels (e.g., paper towels), and combinations thereof.

The hot melt adhesive composition can also be used to form disposable absorbent articles including e.g., diapers, feminine hygiene articles (e.g., sanitary napkins), adult incontinence articles, meat pads, medical gowns, and combinations thereof.

The hot melt adhesive composition is useful as a construction adhesive to bond polymer films (e.g., disposable absorbent articles) to a nonwoven substrate, to bond two nonwoven substrates together, and combinations thereof, as a core adhesive to fix the location of the absorbent material (e.g., fluff, superabsorbent polymer, and combinations thereof) during manufacture and use of the disposable absorbent article, as an elastic attachment adhesive to bond elastic strands to polyethylene or polypropylene films and nonwoven substrates and as a positioning adhesive to enable positioning of a feminine hygiene product such as a sanitary napkin or pantyliner on an article of clothing, which can be made from a variety of materials including, e.g., cotton, synthetic microfiber, nylon, and combinations thereof.

The hot melt adhesive composition can be applied to a substrate in any useful form including, e.g., as a coating (e.g., a continuous coatings and discontinuous coatings (e.g., random, pattern, and array)), as a bead, as a film (e.g., a continuous films and discontinuous films), and combinations thereof, using any suitable application method including, e.g., slot coating, spray coating (e.g., spiral spray, random spraying, and random fiberization (e.g., melt blowing), foaming, extrusion (e.g., applying a bead, fine line extrusion, single screw extrusion, and twin screw extrusion), wheel application, noncontact coating, contacting coating (e.g., direct coating), gravure, engraved roller, roll coating, transfer coating, screen printing, flexographic, “on demand” application methods, and combinations thereof.

In on demand hot melt application systems (which are also referred to as “tank free” and “tankless” systems), hot melt compositions are fed in a solid state (e.g., pellets), to a relatively small heating vessel (relative to traditional hot melt applications systems that include a pot) where the hot melt composition is melted and, typically shortly thereafter, the molten liquid is applied to a substrate. In on demand systems, a relatively large quantity of hot melt composition typically does not remain in a molten state for an extended period of time. In many existing on demand systems, the volume of molten hot melt composition is no greater than about 1 liter, or even no greater than about 500 milliliters, and the hot melt composition is maintained in a molten state for a relatively brief period of time, including, e.g., less than one hour, or even less than 30 minutes. Suitable on demand hot melt adhesive application systems include, e.g., InvisiPac Tank-Free Hot Melt Delivery System from Graco Minnesota Inc. (Minneapolis, Minnesota) and the Freedom Hot Melt Dispensing System from Nordson Corporation (Westlake, Ohio). On demand hot melt adhesive application systems are described in U.S. Patent Publication Nos. 2013-0105039, 2013-0112709, 2013-0112279, and 2014-0042182, and U.S. Pat. No. 8,201,717, and incorporated herein.

The invention will now be described by way of the following examples.

### EXAMPLES

### Test Procedures

Test procedures used in the examples include the following. All ratios and percentages are % by weight unless otherwise indicated. The procedures are conducted at room temperature (i.e., an ambient temperature of from about 20° C. to about 25° C.) unless otherwise specified.

### Viscosity Test Method

Viscosity is determined at the specified temperature in accordance with ASTM D-3236 entitled, “Standard Test Method for Apparent viscosity of Hot Melt Adhesives and Coating Materials,” (Oct. 31, 1988), using a Brookfield viscometer (e.g., a Brookfield RVDV-II+), a Brookfield Thermosel heated sample chamber, and a number 27 spindle. The results are reported in centipoise (cP).

### Heat Stability Test Method

Fifty grams of hot melt adhesive composition was weighed into a Azpack™ Clear Glass Wide Neck Powder Bottles 120 ml glass jar, covered with foil, and held at a temperature of 160° C. in a ventilated oven. The sample was evaluated at 8, 24, and 48 hours to check for skinning.

### Softening Point

The softening point was tested using a Ring & Ball method. The rings were filled with molten hot melt adhesive taking care to avoid air bubbles. Excess material was removed using a heated knife or scraper. The surface of the hot melt adhesive is flush with the edges of the ring. The samples were allowed to stand for a minimum of 60 minutes at room temperature. A ball was then added to the top of each sample. The sample was then placed in a test rig, within a 400 ml beaker of glycerin. A calibrated thermometer was inserted such that it was level with the ring. The compete assembly is then placed on a hot plate set to “on”. The hot was set so that the temperature of the glycerin rose at 5° C./min, at some point the hot melt adhesive composition softened, allowing the test balls to drop. The softening point was recorded as the temperature indicated by the thermometer at the instant the test ball touches the horizontal plate beneath the samples.

### Shore Hardness

The hot melt adhesive composition was heated until molten and then poured into a container such that there was a minimum thickness of 6 millimeters. It was then allowed to cool on a flat surface, overnight in a controlled environment i.e., 23° C. and 50% humidity.

A tip was then applied to the probe on the Shore Hardness apparatus. Shore A has a rounded tip to the probe is generally used for softer materials. Shore D has a pointed tip to the probe is generally used for harder materials.

The tip was set zero. With the hot melt adhesive composition on a firm surface, the probe was lowered down to contact the surface of the hot melt adhesive composition. The probe was then engaged and the maximum figure the needle reaches on the gauge was recorded. The test was repeated on a different area of the hot melt block at least another five times. Any unusually high or low values were discarded, and an average of the remaining values was reported.

### Loop Tack

The Loop Tack was performed according to ASTM D 6195-97. The adhesive was coated onto a 100 gram per square meter (gsm) PET film at a coat weight of 80 gsm. A separation rate of 300 millimeters per minute was used. The result was reported in Newtons and was an average of tests.

### 180° Peel Adhesion to Stainless Steel

Peel values were determined using test method #PSTC-1. About 1 mil adhesive film is coated onto polyester (Mylar®) film out of the melt using a hot melt coater/laminator. Samples are then cut into 1 inch by 8 inch strips (2.54 cm×20.32 cm) for determining peel values.

### Flexibility

The flexibility of a one millimeter thick hot melt adhesive composition film aged at the not temperature for 24 hours was evaluated by manipulating and a rough rating assigned: Flexible, Semi-flexible or Brittle.

### EXAMPLES

The components of the hot melt adhesive compositions of Examples 1-27 were combined at room temperature in the amounts set forth in Tables 1-6 (in percent by weight), heated to a temperature sufficient to melt the components (i.e., from 107° C. to 120° C.), and then mixed at a temperature of from 120° C. to 140° C. to form the adhesive composition. The resulting hot melt adhesive compositions were then tested according to the test methods.

TABLE 1
Hot Melt Adhesive for End of Line Packaging

| | Control 1 | Example 1 (2% by |
|---|---|---|
| | (no Masterbatch | weight Masterbatch |
| | additive) | additive 3.1) |
| Viscosity @ 160° C. (cP) | 2585 | 3150 |
| Viscosity @ 180° C. (cP) | 1560 | 1845 |
| Softening Point (° C.) | 108 | 108 |
| Shore D Hardness | 45 | 47 |
| Flexibility @ 23° C. | Flexible | Flexible |
| Flexibility @ 5° C. | Brittle | Brittle |

TABLE 2
Hot Melt Adhesive for Disposable Absorbent Article Construction

| | | Example 2 (2% by |
|---|---|---|
| | Control 2 | weight Masterbatch |
| | (no Masterbatch | additive 3.1; 0.4% |
| | additive) | Irganox 1010) |
| Color | Water white | Pale Amber |
| Viscosity @ 140° C. (cP) | 7875 | 8750 |
| Viscosity @ 160° C. (cP) | 3865 | 4265 |
| Viscosity @ 180° C. (cP) | 2118 | 2308 |
| Softening Point (° C.) | 81 | 87 |
| Loop Tack | 38 | 43 |
| Shore A Hardness | 28 | 32 |
| Heat Stability | No color change | Color darkened; No |
| (48 hrs @ 160° C.) | | skinning |

Masterbatch additive 3.1, commercially available from Polymateria Limited (London, U.K.) could be included in the hot melt adhesive composition at 2% by weight without significantly impacting the properties of the hot melt adhesive composition.

TABLE 3

| | Comp 1 | Ex 1 | Ex 2 | Ex 3 | Ex 4 | Ex 5 | Ex 6 | Ex 7 | EX 8 |
|---|---|---|---|---|---|---|---|---|---|
| | weight | weight | weight | weight | weight | weight | weight | weight | weight |
| | % | % | % | % | % | % | % | % | % |
| ENGAGE 8407 | 12 | 12 | 12 | 12 | 12 | 12 | 12 | 12 | 12 |
| AFFINITY GA 1900 | 18 | 18 | 18 | 18 | 18 | 18 | 18 | 18 | 18 |
| 120° C. DCPD Resin | 48 | 47.6 | 47.6 | 47.6 | 47.5 | 47.7 | 47.6 | 47.5 | 47.25 |
| 100° C. Fischer Tropsch Wax | 20 | 20 | 20 | 20 | 20 | 20 | 20 | 20 | 20 |
| Masterbatch Additive 3.1 | 2 | 2 | 2 | 2 | 2 | 2 | 2 | 2 | 2 |
| IRGANOX 1010 sterically | | 0.2 | 0.2 | 0.2 | 0.1 | 0.3 | 0.4 | 0.5 | |
| hindered primary phenolic | | | | | | | | | |
| antioxidant | | | | | | | | | |
| IRGANOX 1076 sterically | | | | | | | | | 0.75 |
| hindered primary phenolic | | | | | | | | | |
| antioxidant | | | | | | | | | |
| IRGAPHOS 168 Tris (2,4- | | 0.1 | | 0.2 | 0.4 | | | | |
| di-tert.-butylphenyl) | | | | | | | | | |
| phosphite | | | | | | | | | |
| SONGNOX PQ | | | 0.2 | | | | | | |
| Phosphonite secondary | | | | | | | | | |
| antioxidant; Phosphorous | | | | | | | | | |
| trichloride, reaction | | | | | | | | | |
| products with 1,1′-biphenyl | | | | | | | | | |
| and 2,4-bis(1,1- | | | | | | | | | |
| dimethylethyl) phenol | | | | | | | | | |
| Total antioxidant | </=0.2 | | | | | | | | |
| Heat Stability | | | | | | | | | |
| 8 hours at 160° C. | Skinned | OK | OK | OK | OK | OK | OK | OK | OK |
| 24 hours at 160° C. | Skinned | Skinned | OK | OK | OK | Skinned | OK | OK | OK |
| 48 hours at 160° C. | Skinned | Skinned | OK | OK | Skinned | Skinned | OK | OK | OK |
| Ecotoxicity Test | NT | NT | Did not | Pass | NT | NT | Pass | NT | NT |
| OECD 208, OECD 211, | | | pass | | | | | | |
| and OECD 222 | | | | | | | | | |
| Weathering Test | NT | NT | NT | Did not | NT | NT | Pass | NT | NT |
| PAS 9017: 2020 | | | | pass | | | | | |

NT (Not Tested)

Other embodiments are within the claims. All documents referred to herein are incorporated to the extent they do not conflict.

1. A hot melt adhesive composition comprising:
a. from 7.5% by weight to 95% by weight of an olefin polymer,
b. from 0.15% by weight to 1.0% by weight of an antioxidant,
c. from 0.005% by weight to 0.4% by weight of a saturated, or mono- or poly-unsaturated C 14-C 24 linear carboxylic acid, or an ester, anhydride or amide thereof, and
d. from 0.02% by weight to 1.2% by weight of a transition metal compound, wherein the transition metal is selected from the group consisting of iron, manganese, copper, cobalt and cerium.

2. The hot melt adhesive composition of claim 1 further comprising from 0.005% by weight to 0.6% by weight of an unsaturated synthetic rubber.

3. The hot melt adhesive composition of claim 1 wherein the saturated, or mono- or poly-unsaturated C14-C24 linear carboxylic acid, or an ester, anhydride or amide thereof is selected from the group consisting of consisting of oleic acid, linoleic acid and cinnamic acid.

4. The hot melt adhesive composition of claim 1 wherein the transition metal compound is a transition metal stearate.

5. The hot melt adhesive composition of claim 1 wherein the hot melt adhesive composition passes:
a. British Standards Document PAS 9017:2020 Entitled: Biodegradation of polyolefins in an open-air terrestrial environment, and
b. Eco-toxicity tested under Organization for Economic Co-operation and Development (OECD) 208, OECD 211, and OECD 222.

6. The hot melt adhesive composition of claim 1 having a Brookfield viscosity of from 50 cP to 20,000 cP when tested at 160° C.

7. The hot melt adhesive composition of claim 1 comprising from 0.2% by weight to 0.9% by weight of the antioxidant.

8. The hot melt adhesive composition of claim 1 comprising from 0.3% by weight to 0.8% by weight of the antioxidant.

9. The hot melt adhesive composition of claim 1 wherein the antioxidant is selected from the group consisting phenolic antioxidant, phosphite antioxidant and combinations thereof.

10. The hot melt adhesive composition of claim 1 wherein the antioxidant comprises a phenolic antioxidant.

11. The hot melt adhesive composition of claim 1 comprising from 10% by weight to 60% by weight of the olefin polymer.

12. The hot melt adhesive composition of claim 1 comprising from 40% by weight to 60% by weight of the olefin polymer.

13. The hot melt adhesive composition of claim 1 further comprising a tackifying agent and a wax.

14. A hot melt adhesive composition comprising:
a. from 10% by weight to 70% by weight of an olefin polymer,
b. from 10% by weight to 65% by weight of a tackifying agent,
c. from 5% by weight to 45% by weight of a material selected from the group consisting of wax, plasticizer, and a combination thereof,
d. from 0.2% by weight to 0.9% by weight of an antioxidant,
e. from 0.005% by weight to 0.4% by weight of a saturated, or mono- or poly-unsaturated C 14-C 24 linear carboxylic acid, or an ester, anhydride or amide thereof,
f. from 0.02% by weight to 1.2% by weight of a transition metal compound, wherein the transition metal is selected from the group consisting of iron, manganese, copper, cobalt and cerium, and
g. from 0.005% by weight to 0.6% by weight of an unsaturated synthetic rubber.

15. The hot melt adhesive composition of claim 14 wherein the olefin polymer is a ethylene polymer having a MFR of from 5 grams (g)/10 minutes to 200 g/10 minutes when measured by according to ASTM D1238A-20 at 190° C. using a 2.16 kg load, the tackifying agent is a hydrogenated hydrocarbon, and the hot melt adhesive composition comprises from 5% by weight to 45% by weight of a wax.

16. The hot melt adhesive composition of claim 1 wherein the hot melt composition includes from 20% by weight to 100% by weight of sustainable components.

17. The hot melt adhesive composition of claim 1 having a total bio-based carbon content according to ASTM 6866-20 of from 30% by weight to 100% by weight based on the total carbon content.

18. An article that passes British Standards Document PAS 9017:2020 Entitled: Biodegradation of polyolefins in an open-air terrestrial environment comprising the hot melt adhesive composition of claim 1.

19. The article of claim 18 selected from the group consisting of case, carton, container, disposable paper product, paper bag, straw, disposable absorbent article, label, mailer, cigarette, cigar and agriculture product.

20. The article of claim 18 selected from the group consisting of a case, carton and container.
